(19) United States
(12) Patent Application Publication
(10) Pub. No.: US 2017/0309038 A1
(43) Pub. Date: Oct. 26, 2017

(54) DETECTING A PRESENCE OF A TARGET IN A ROOM

(71) Applicant: Analog Devices Global, Hamilton (BM)

(72) Inventors: Pascal Dorster, Fribourg (CH); Peeyush Bhatia, Hauterive (CH)

(73) Assignee: Analog Devices Global, Hamilton (BM)

(21) Appl. No.: 15/492,665

(22) Filed: Apr. 20, 2017

Related U.S. Application Data
(60) Provisional application No. 62/326,179, filed on Apr. 22, 2016.

(51) Int. Cl. G06T 7/70; G08B 13/189; G01J 5/00; H04N 5/33

(52) U.S. Cl. CPC G06T 7/70; H04N 5/33; G08B 13/189; G01J 5/0025; G06T 2207/10016; G06T 2207/30196

(57) ABSTRACT

Apparatus for detecting a presence of a target in a room is disclosed. The apparatus includes a motion-sensitive passive infrared (PIR) sensor, an imaging sensor, and a control unit. The PIR sensor is adapted to provide a motion signal, while the imaging sensor is adapted to generate at least a first image and a second image. The control unit is adapted to provide either a first signal or a second signal, depending on the strength of the motion and a comparison of the first and second images, where the first signal indicates a presence of the target and the second signal indicates an absence of the target. Also disclosed are a system for controlling lighting in a room, a method for detecting a presence of a target in a room, and a corresponding use of an apparatus for controlling lighting in a room.

### CROSS-REFERENCE TO RELATED APPLICATIONS

This application claims the benefit of and priority from U.S. Provisional Patent Application Ser. No. 62/326,179 filed 22 Apr. 2016 entitled “DETECTING A PRESENCE OF A TARGET IN A ROOM”, incorporated herein by reference in its entirety.

### TECHNICAL FIELD OF THE DISCLOSURE

The present disclosure relates to the field of digital signal processing, in particular to digital signal processing for tracking a heartbeat frequency in a noisy environment.

### BACKGROUND

Various applications require information about the occupancy of a room, i.e., whether a target is present in the room or absent from the room. For some applications the target is a human being, i.e., it is desired to determine whether a human being is present in a room or not. One specific application may be a security application where it is desired to determine whether a human being is unexpectedly present so that an alarm can be sounded.

One of the most common means for determining the occupancy of a room is to use a traditional motion detection sensor, in particular a passive infrared (PIR) sensor. A PIR sensor will detect thermal motion in a room. If such thermal motion is detected, it is concluded that a target, in particular a human being, is present in the room.

However, this approach suffers from a number of drawbacks. For practical applications, the sensitivity of the PIR sensor has to be set rather low, in order to avoid the undesired detection of thermal artifacts, e.g., effects caused by heating, ventilation and air conditioning (HVAC). The low sensitivity, however, has the effect that a significant thermal motion is required in order to determine the presence of the target. Therefore, the presence will only be detected with a notable delay.

Many PIR sensors do not provide spatial information or only very limited spatial information. This makes it impossible or at least very difficult to determine the position of the thermal source indicating a motion. Therefore, the detection of a motion by the PIR sensor would indicate the presence of the target, even if the motion occurred in an area which, if a target is detected in that area, is not to be understood as a presence of the target in the room.

To improve this situation, imaging sensors have been used for occupancy detection. Due to their good spatial resolution and the available technologies for image processing and image comparison, these imaging sensors can address the disadvantages of PIR sensors. However, imaging sensors have limitation of their own.

On the one hand, imaging sensors provide no or only inferior results under low light conditions, including conditions without any light. Such conditions do not allow to reliably determine a vacant or an occupied state. Also, moving artifacts, such as light beams or shadows can falsely indicate the presence of the target, even though the presence of the target should not be indicated.

### SUMMARY OF THE DISCLOSURE

The present disclosure is directed at an apparatus for detecting a presence of a target in a room and a corresponding method for detecting a presence of a target in a room. The present disclosure is further directed at a system for controlling lighting in a room and at a use of an apparatus for controlling lighting in a room depending on a presence of a target.

One object of the present disclosure is to overcome some the problems of prior art occupancy detectors. Another object is to disclose an approach for reliably detecting a presence of a target in a room. It is yet a further object to disclose a cost-effective solution.

According to one aspect of the present disclosure, an apparatus may include a motion-sensitive PIR sensor with a first field of view, an imaging sensor with a second field of view, and a control unit connected to the PIR sensor and to the imaging sensor and having an output, where the PIR sensor is adapted to provide a motion signal indicative of a motion detected in the first field of view, the imaging sensor is adapted to capture a scene in the second field of view and to generate at least a first image at a first time and a second image at a second time after the first time, and the control unit is adapted to provide one of a first signal and a second signal different from the first signal depending on the strength of the motion detected and a comparison of the first image and the second image for differences indicating a motion, where the first signal is adapted to indicate the presence of the target and the second signal is adapted to indicate an absence of the target.

The disclosed apparatus makes synergistic use of the motion signal provided by the PIR sensor and the comparison of the first image and the second image. Generally speaking, the apparatus may be configured to make use of the PIR sensor under low light conditions, and use the PIR sensor to verify the result of the comparison otherwise. The details of this synergistic effect will be explained with reference to exemplary embodiments.

According to another aspect of the present disclosure, a system for controlling lighting in a room is provided, the system including an apparatus as described herein and at least one light source connected to the output of the control unit, where the light source is adapted to be controlled based on the first signal and the second signal. For example, the first signal can be used to turn on the light source, and the second signal can be used to turn off the light source.

According to yet another aspect of the present disclosure, a method for detecting a presence of a target in a room is provided. The method includes providing a motion signal indicative of a motion detected in a first field of view of a motion-sensitive PIR sensor, generating at least a first image at a first time and a second image at a second time (after the first time) of a scene in a second field of view of an imaging sensor, and providing one of a first signal and a second signal, different from the first signal, depending on the strength of the motion detected and a comparison of the first image and the second image for differences indicating a motion, where the first signal indicates a presence of the target and the second signal indicates an absence of the target.

According to yet another aspect, a use of an apparatus as described above for controlling lighting in a room depending on the presence of the target is disclosed.

It is understood that all features explained above and in the following are not limited to only being implemented as explained for a particular embodiment, but may also be combined in other combinations, or used in isolation. Any embodiment is understood to be an exemplary embodiment disclosed for the purpose of better understanding the disclosure and is not intended to limit the disclosure.

As will be appreciated by one skilled in the art, aspects of the present disclosure may be embodied in various manners—e.g. as a method, a system, a computer program product, or a computer-readable storage medium. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by one or more processing units, e.g. one or more microprocessors, of one or more computers. In various embodiments, different steps and portions of the steps of each of the methods described herein may be performed by different processing units. Furthermore, aspects of the present disclosure may take the form of a computer program product embodied in one or more computer readable medium(s), preferably non-transitory, having computer readable program code embodied, e.g., stored, thereon. In various embodiments, such a computer program may, for example, be downloaded (updated) to the existing devices and systems (e.g. to the existing lighting systems or light controllers, etc.) or be stored upon manufacturing of these devices and systems.

Other features and advantages of the disclosure are apparent from the following description, and from the claims.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 provides a schematic illustration of an apparatus for detecting a presence of a target in a room, according to some embodiments of the present disclosure;

FIG. 2 provides a schematic illustration of the choice of a first and a second predetermined area in a room as viewed by the imaging sensor, according to some embodiments of the present disclosure;

FIG. 3 provides a schematic illustration of a system for controlling lighting in a room, according to some embodiments of the present disclosure;

FIG. 4 provides a schematic illustration of a method for detecting a presence of a target in a room, according to some embodiments of the present disclosure;

FIG. 5 provides a schematic illustration of selecting the low threshold and/or the high threshold of the motion signal from the PIR sensor, according to some embodiments of the present disclosure;

FIG. 6 provides a schematic illustration of different options on how to provide one of a first signal and a second signal depending on the strength of the motion detected and a comparison of the first image and the second image, according to some embodiments of the present disclosure; and

FIG. 7 depicts a block diagram illustrating an exemplary data processing system, according to some embodiments of the disclosure.

### DESCRIPTION OF EXEMPLARY EMBODIMENTS

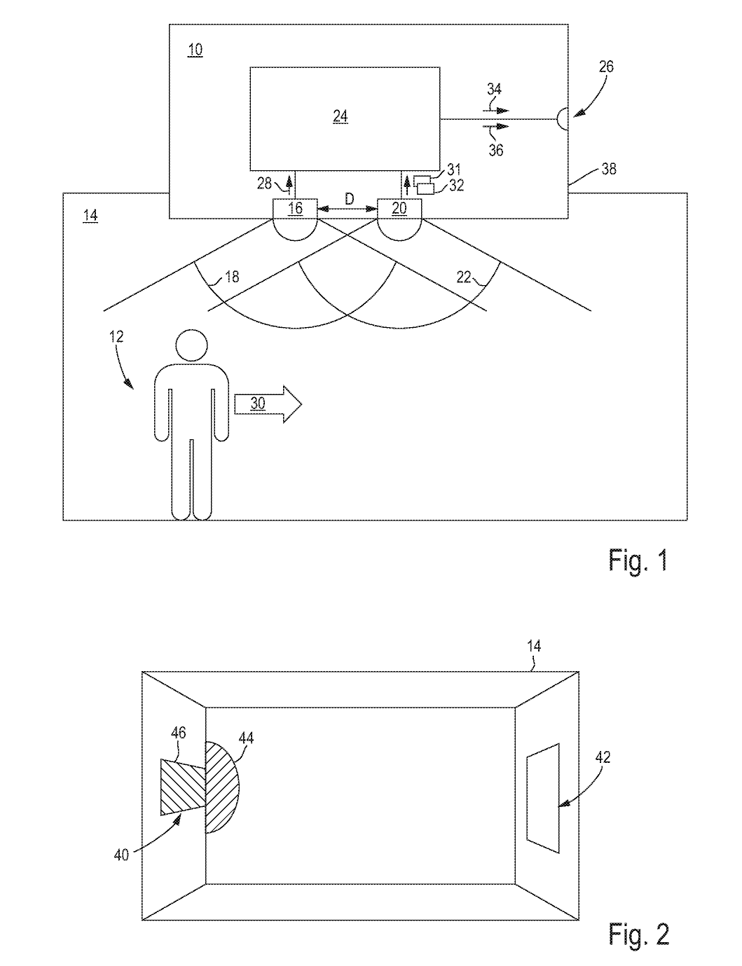

FIG. 1 discloses an apparatus 10 for detecting a presence of a target 12 in a room 14. The apparatus 10 includes a motion-sensitive PIR sensor 16 with a first field of view 18, and an imaging sensor 20 with a second field of view 22. Further, the apparatus 10 includes a control unit 24 connected to the PIR sensor 16 and to the imaging sensor 20. The control unit 24 has an output 26.

In general, the “room 14” may be any scene (i.e. not necessarily a room), and the “target 12” may be any live target whose motion can be detected based on thermal measurements by the PIR sensor 16 (i.e. not necessarily a human being).

The PIR sensor 16 is configured to detect thermal motion in a room, in any of the manners known in the art, and to provide to the control unit 24 a motion signal 28 indicative of a motion of the target 12 (the motion of the target is schematically illustrated in FIG. 1 with an arrow 30) detected in the first field of view 18. In particular, analysis of the strength of the motion signal 28 allows estimation of a motion of the target 12 in the first field of view 18, which analysis may be carried out in any of the manners known in the art. In some embodiments, the control unit 24 may be configured to determine the strength of the motion signal 28 to estimate the motion of the target. In other embodiments, estimation of the motion may be carried out by another entity, e.g. by a processing device of the PIR sensor 16, and results provided to the control unit 24.

The imaging sensor 20 is configured to capture a scene in the second field of view 22 and to generate at least a first image 31 at a first time and a second image 32 at a second time, the second time being after the first time. The first and second images 31, 32 are also provided to the control unit 24. Comparison of the first and second images 31, 32 for differences allows estimation of a motion of the target 12 in the second field of view 22, which comparison and estimation may also be carried out in any of the manners known in the art. In some embodiments, the control unit 24 may be configured to compare the first and second images 31, 32 to estimate the motion of the target. In other embodiments, estimation of the motion may be carried out by another entity, e.g. by a processing device of the imaging sensor 20, and results provided to the control unit 24.

In various embodiments, the imaging sensor 20 may be configured to provide the first and second images 31, 32 as two-dimensional spatial data comprising information on luminance distribution or contrast distribution. This refinement allows for a good detection of motion based on the first and second images.

In a further refinement, the control unit 24 may be configured to determine that the comparison of the first and second images indicates a motion in the second field of view only if a moving shape determined by the comparison meets at least one predefined criterion. This refinement may improve the confidence that a target is actually present when a target is detected as described. For example, the criterion may be that the area of the second field of view affected by the motion has a minimum size and/or that the speed of the motion is within certain limits. According to some exemplary embodiments, the at least one criterion may be chosen such that only the actual presence of a target, in particular a human being, leads to providing the first signal, and that artifacts are not interpreted as the presence of the target or only within a small margin of error. The moving shape may be determined using known image analysis algorithms applied to the first and second images.

For some exemplary embodiments, the time interval between the time when the first image 31 is taken and the time when the second image 32 is taken is relatively small, e.g. less than 5 seconds, or less than 2 seconds, or less than 1 second, or less than 0.5 seconds. In some embodiments, the imaging sensor 20 may be configured to continually update the first and second images. Other exemplary embodiments may use the first image as a reference image taken at a particular time and with the second image being continually updated. For such embodiments, the time interval for updating the first image may be greater than 15 seconds, or greater than 1 minute or greater that 5 minutes. The time interval for updating the second image may be less than 5 seconds, or less than 2 seconds, or less than 1 second or less than 0.5 seconds.

The control unit 24 is configured to process results of analyzing the motion signal 28 and results of the comparison of the first and second images 31, 32 to generate one of a first signal 34 and a second signal 36, the second signal 36 being different from the first signal 34, depending on the strength of the motion 30 detected, and on a comparison of the first image 31 and the second image 32 for differences indicating the motion 30. The first signal 34 indicates a presence of the target 12 and the second signal 36 indicates an absence of the target 12. In order to ease the understanding of the disclosed approach, the first signal 34 may be understood as an indication of “occupied”, and the second signal 36 may be understood as an indication of “vacant” in the context of exemplary embodiments. Thus, the apparatus 10 allows making synergistic use of the motion signal 28 provided by the PIR sensor 16 and the comparison of the first image and the second image captured by the imaging sensor 20 to detect presence of the target 12 in the room 14.

For example, in some embodiments, the control unit 24 may be configured to provide the first signal 34 if the comparison of the first and second images indicates a motion, and if the motion signal 28 from the PIR sensor 16 is above a noise level of the motion signal 28 (some examples of the noise levels are described below with reference to FIG. 5). Thus, the control unit 24 may be configured to make use of the motion signal 28 from the PIR sensor in order to verify that the indication of a motion based on the comparison of the first and second images 31, 32 is not caused by an artifact. If the motion detected by the comparison of images 31, 32 is affected by motion of the target, the motion signal from the PIR sensor 16 is expected to be above a noise level. In the context of the present disclosure, the motion signal 28 from the PIR sensor 16 exceeding a noise level of the motion signal can e.g. be understood as exceeding a low threshold of the motion signal.

In some embodiments, the control unit 24 may be configured to provide the second signal 36 if the comparison of the first and second images indicates a motion of the target, and if the motion signal 28 from the PIR sensor does not exceed a certain noise level of the motion signal.

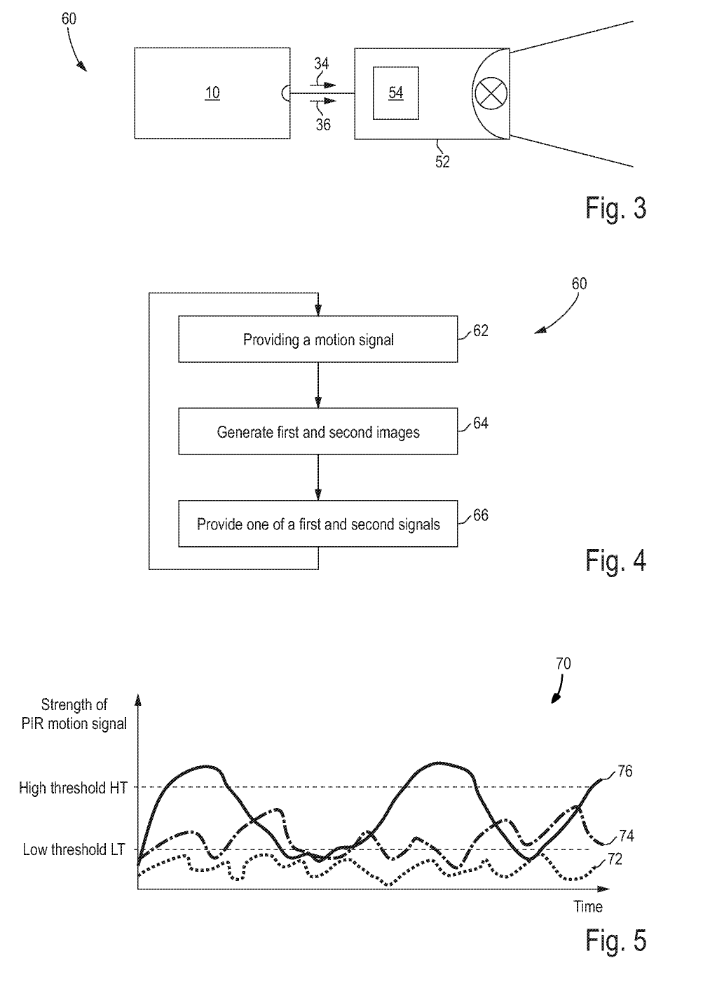

In exemplary embodiments, the first and second signals 34, 36 may be used to perform a first and second action, respectively, or to enter a first and a second state, respectively. For example, the control unit 24 may be configured to apply whichever one of the signals 34, 36 the control unit 24 generated to a lighting system that includes one or more light sources (e.g. to a lighting system as shown in FIG. 3). Using the first and second signals 34, 36 to control light sources is just one of the deployment scenarios in which the apparatus 10 may be used. In other embodiments, the control unit 24 may be configured to apply the first and second signals 34, 36 to any of systems beyond lighting systems to control functionality of such systems—e.g. to control operation of an air-conditioning system (e.g. to turn on or off, or to change the operational settings of one or more devices of an air-conditioning system), to control appliances such as e.g. various home appliances, to issue an alarm and initiate protective measures (e.g. lock up doors or/and windows) in case a trespasser is detected in a secured area, etc. In general, the control unit 24 may be configured to apply the one of the generated signals 34, 36 to ensure that one or more further devices (e.g. light sources of a lighting system) are set to a first operating state (e.g. lights are turned on), in case the control unit 24 generated the first signal 34, or to ensure that the further devices are set to a second operating state (e.g. lights are turned off), in case the control unit 24 generated the second signal 36. In some embodiments, the first state could be a state where the devices are turned on, while the second state could be a state where the devices are turned off. In other embodiments, the first and second states could be such that e.g. the first state is a state where the devices consume more power compared to the second state (in other words, the second state could be some kind of a low-power state). Still in other embodiments, the first and second states could be any states which differ in how devices operate when in each of those states. In context of the present disclosure, “ensuring” that further devices are set to a particular operating state includes switching the devices to operate in this particular operating state if the devices were previously operating in a different state (e.g. turning the light sources on if the light sources were previously off), or keeping the devices operating in this particular operating state if the devices were already operating in this state (e.g. keeping the light sources turned on if they were previously on).

In some embodiments, the control unit 24 may be configured so that using the first and second signals 34, 36 to perform an action or enter a state can be delayed in response to a transition from the first signal to the second signal or from the second signal to the first signal. For example, in some exemplary embodiments, after generating the second signal, there is a certain delay, i.e. waiting time, before the light source is actually turned off (or, more generally, put in some kind of second state). If during this time the first signal is output, the light source will not be turned off (or, more generally, will not be put in a second state). Upon a further transition from the first signal to the second signal, the waiting time may be started again from the beginning. This refinement avoids a situation where the target is not moving enough to trigger positive motion detection, e.g. the target is a person reading a book. The light source will only be turned off, or, more generally, be put in a second state, after it is asserted that no motion has been detected during the waiting time. In some embodiments the control unit 24 may implement such delays. In other embodiments, lighting control unit 54 may be configured to implement such delays based on the first and second signals received from the control unit 24.

In some embodiments, the control unit 24 may be configured so that using the first and second signals 34, 36 to perform an action or enter a state is carried out after the first signal or the second signal (whichever the control unit 24 generated) is generated several times in a row.

It should be noted that the control unit 24 may also provide other signals beyond the first and second signals 34, 36.

In some exemplary embodiments the first signal and the second signal may be individually defined, e.g. as “high” and “low”, or “5 Volt” and “0 Volt”, or the like. In other exemplary embodiments, only one of the first and second signals is defined and the second signal is identified as “not the first signal” or the first signal is identified as “not the second signal”.

In various embodiments, the first field of view and the second field of view may, but do not have to be substantially the same. However, in order to make the synergistic use of the motion signal and the comparison, the first and second fields of view 18, 22 may overlap. The overlapping region of the first and second fields of view will cover a scene, i.e. a region of interest in the room 14. In particular, the scene is to be understood as a view of the observed space captured at any moment of time.

The PIR sensor 16 and the imaging sensor 20 may be arranged in proximity, with a distance D apart from each other. In some embodiments, the PIR sensor 16 and the imaging sensor 20 may be arranged in a common housing 38, which allows for a compact design. In exemplary embodiments, the PIR sensor 16 and the imaging sensor 20 may be less than 30 cm apart, or less than 15 cm, or less than 10 cm, or less than 5 cm. In some further embodiments, the control unit 24 may also be arranged in the common housing 38. In some exemplary embodiments, the housing 38 may be provided as one integral piece.

In some exemplary embodiments, when one or more of the acquired images are indicative of low light conditions, the control unit 24 may be configured to use the motion information from the PIR sensor 16 alone, i.e. the control unit 24 may be configured to disregard the results of the comparison of the first and second images 31, 32 when these images are indicative of low light conditions. A low light condition can be determined, for example, by a lack of brightness and/or a lack of contrast in the images obtained from the imaging sensor 20 and may be performed by analyzing the images as known in the art. On the other hand, when the acquired images are indicative of sufficient light available, the control unit 24 may be configured to use the motion information from the PIR sensor 16 as a secondary information to motion determination based on the comparison of the first and second images 31, 32. In other words, while the information from the PIR sensor 16 is used to supplement information from the imaging sensor 20, it does not need to be used in isolation when sufficient light is available.

For example, in some embodiments, the control unit 24 may be configured to provide the second signal 36 if the control unit 24 determines a low light condition based on at least one of the first image and the second image, and if the motion signal from the PIR sensor 16 is below a high threshold of the motion signal. This refinement addresses the situation that, in a low light condition, determining a motion based on the comparison of images 31, 32 may be not possible or unreliable. In such situations, an absence of the target will be indicated as long as the motion signal from the PIR sensor 16 is below the high threshold. In the context of the present disclosure, the high threshold may be understood as a threshold with a high signal-to-noise ratio (SNR), which is either clearly indicative of the presence of the target, or at least has a high confidence that the target is present.

On the other hand, in some embodiments, the control unit 24 may be configured to provide the second signal 36 if the control unit 24 determines no low light condition is present, based on at least one of the first image and the second image, and if the comparison of the first and second images does not indicate a motion. Such functionality helps to ensure that the second signal 36 is provided if the target is absent. If no low light condition is present, it is assumed that the presence of the target could be determined based on the motion of the target as e.g. determined by comparison of the images acquired by the imaging sensor 20 alone. Consequently, if the first and second images do not indicate a motion when sufficient light is available, the absence of the target is established.

In an exemplary embodiment, the control unit 24 may be configured to provide the first signal 34 if the control unit 24 determines a low light condition based on at least one of the first image and the second image, and if the motion signal from the PIR sensor is above a high threshold of the motion signal.

In some embodiments, the control unit 24 may be configured to provide the first and second signals 34, 36 based on the areas in which the motion was detected by means of analyzing the motion signal 28 of the PIR sensor 16 or by means of comparing the first and second images 31, 32 of the imaging sensor 20. To that end, at least two areas are defined, referred to in the following as a first and second predetermined areas, and the control unit 24 is provided with information identifying such areas in a manner that would allow the control unit 24 to differentiate between motion detected in these areas.

FIG. 2 provides a perspective top-down illustration of the room 14 for explaining the concept of the first and second predetermined areas. Consider, for example, that the room 14 has an entrance 40 and a window 42. FIG. 2 may be viewed as a simplified representation of the second field of view 22 of the imaging sensor 20. For the purposes of illustration, a first predetermined area 44 and a second predetermined area 46 are shown in FIG. 2 with different patterns.

The first predetermined area 44 may represent an entry area where a target 12 will enter the room 40. The second predetermined area 46 may represent an area where the presence of a target 12 should not trigger the first signal, e.g., “occupied”. For example, the second predetermined area 46 can represent a section of a corridor.

If the control unit 24 detects the motion in the first predetermined area 44 based on the comparison of the first and second images 31, 32, the motion signal 28 from the PIR sensor 16 may be rather weak, but above the noise level of the motion signal 28. Still, since a motion in the first predetermined area is determined based on the image comparison and the motion signal 28 from the PIR sensor is above the noise level, the control unit 24 is configured to provide the first signal 34 in order to quickly react to the target 12 entering the room 14.

If the control unit 24 detects the motion in the second predetermined area 46 but not in the first predetermined area 44, it can be assumed that the target 12 has not entered the room 14, in fact, the target 12 may not even intend to enter the room 14. In particular, the control unit 24 may detect such motion based on the motion signal 28 from the PIR sensor being above the noise level or above the low threshold, while the comparison of images 31, 32 indicate that there is no motion in the first predetermined area 44. If the control unit 24 does not detect motion in the first predetermined area 44 but detects the motion in the second predetermined area 46, the control unit 24 will generate the second signal 36 (i.e. the control unit 24 may generate the second signal 36 even though the motion signal 28 from the PIR sensor 16 may indicate a possible presence of the target 12).

Thus, according to a further refinement embodiment, the control unit 24 may be configured to provide the first signal 34 if the comparison of the first and second images 31, 32 indicates a motion in a first predetermined area of the second field of view 22 and if the motion signal 28 from the PIR sensor 16 is above a noise level of a motion signal. This refinement puts focus on the first predetermined area of the second field of view. The first predetermined area may correspond to an area of the scene where a target is likely to enter the scene. In exemplary embodiments, the first predetermined area corresponds to one or more entry areas into the room. If motion is detected in the first predetermined area, it is assumed that the target is present, even though there may not be a strong motion signal yet. However, since the motion signal from the PIR sensor is above the noise level of the motion signal, and since the comparison indicates a motion, it is assumed that a target is present, e.g. entering the room, and the first signal indicating the presence of the target is provided.

In various embodiments, the first predetermined area may be less than the second field of view. For example, the first predetermined area may be less than 50% of the second field of view, or less than 25% of the second field of view, or less than 10% of the second field of view, or less than 5% of the second field of view.

In some embodiments, the control unit 24 may be configured to keep a signal present at the output unchanged if the comparison of the first and second images indicates a motion only outside of the first predetermined area.

In a refinement, the control unit 24 may be configured to provide the second signal if the comparison of the first and second images indicates a motion only in a second predetermined area of the second field of view, in particular if the motion signal from the PIR sensor is above a low threshold. This refinement considers the situation that the second field of view captures an area of the scene which should not indicate the presence of a target even if motion is detected in this area. Such area could be, for example, a corridor where people are passing by. Such motion can be detected by the PIR sensor so that the motion signal from the PIR sensor goes above a low threshold, i.e., goes above the noise level of the motion signal. Thus, if the comparison indicates a motion only in the second predetermined area, the absence of the target will be indicated, even if the motion signal from the PIR sensor being above the low threshold could be an indication for the presence of the target.

FIG. 3 shows a system 50 for controlling lighting in a room 14, the system 50 comprising an apparatus 10 as described above and a light source 52 connected to the output 26 of the control unit 24. The light source 52 is adapted to be controlled based on the first signal 34 and the second signal 36.

Further there is shown a lighting control unit 54 which may affect the control of the light source 52. For example, the lighting control unit 54 can delay a response to the second signal 36 as has been explained above. The lighting control unit 54 may also be arranged outside of the light source 52, for example in the apparatus 10. In some embodiments, the control unit 24 may also perform the functionality of the lighting control unit 54.

FIG. 4 shows an embodiment of a method 60 for detecting a presence of a target 12 in a room 14. In task 62, the motion-sensitive PIR infrared sensor 16 provides to the control unit 24 a motion signal 28 indicative of a motion 30 detected in the first field of view 18. In task 64, which may take place before, after, or at least partially simultaneously with the task 62, the imaging sensor 20 generates and provided to the control unit 24 at least a first image 31, generated at a first time, and a second image 32, generated at a second time after the first time. The first and second images 31, 32 represent a scene in a second field of view 22 of the imaging sensor 20.

In task 66, the control unit 24 generates one of a first signal 34 and a second signal 36 different from the first signal 34, depending on the strength of the motion 30 detected (as indicated e.g. by the motion signal 28) and a comparison of the first image 31 and the second image 32 for differences indicating the motion 30. The first signal 34 is adapted to indicate the presence of the target 12 and the second signal 36 is adapted to indicate an absence of the target 12.

FIG. 5 shows a diagram 70 illustrating an embodiment for choosing a high threshold (HT) and a low threshold (LT) for the motion signal from the PIR sensor 16. In FIG. 5, time is displayed along the X-axis, and the amplitude or strength of the PIR motion signal 28 is displayed along the Y-axis. Three signals are laid upon each other in order to allow an easy understanding of the high and low thresholds.

The dotted line 72 represents an example when the motion signal 28 generate by the PIR sensor 16 is substantially only noise, e.g. the line 72 can represent the motion signal 28 generated when the room 14 is empty and without HVAC engaging. The dash-dotted line 74 represents an example of the motion signal 28 generated by the PIR sensor 16 when the room 14 is empty but with HVAC engaging. The solid line 76 represents an example of the motion signal 28 when movements of the target 12 are present.

The low threshold LT may be chosen as the noise level or the maximum of the noise signal 72. Alternatively, as is depicted in FIG. 5, the low threshold LT may be chosen to be above the noise signal 72 by a certain amount.

The high threshold HT may be chosen such that, when the motion signal 28 exceeds the high threshold HT, it is a clear indication of the presence of the target 12, or at least a determination that the target 12 is present is given with a high confidence. In particular, the high threshold HT is chosen such that it is exceeded when the target 12 moves around in the room 14.

The range between the low threshold LT and the high threshold HT is a range where the motion signal 28 from the PIR sensor 16 could indicate the presence of the target 12, but could also be caused by an artifact.

Various thresholds for detecting movement, such as e.g. the low threshold LT and the high threshold, can be provided to the control unit 24 (e.g. predetermined, pre-programmed, dynamically determined, calculated, etc.), in order to enable the control unit 24 to make decisions about presence of target the room based on the motion signal 28.

For example, in some embodiments, the control unit 24 may be configured to provide the first signal 34 if the motion signal 28 from the PIR sensor is above a relatively high threshold, such as e.g. the high threshold HT shown in FIG. 5. Such embodiments are adapted to handle situations where a strong signal from the PIR sensor, i.e., a motion signal above the high threshold, is a strong indication of the presence of the target. As explained above, since the apparatus 10 relies on a synergetic use of information from the imaging sensor 20 and the PIR sensor 16, the high threshold can be selected high enough so that artifacts will not be considered as a motion of the target or that there is at least a high confidence that no artifacts are detected.

In another example, in some embodiments, the control unit 24 may be configured to compare the strength of the motion detected, as expressed by the motion signal 28, to a relatively low threshold, such as e.g. the low threshold LT shown in FIG. 5, where the low threshold may be set to correspond to a target entering the first field of view 18. Comparing the motion signal 28 to such a low threshold is likely to avoid interpreting the noise of the PIR sensor 16 as motion while still being sensitive to a motion signal that could be indicative of a motion of the target.

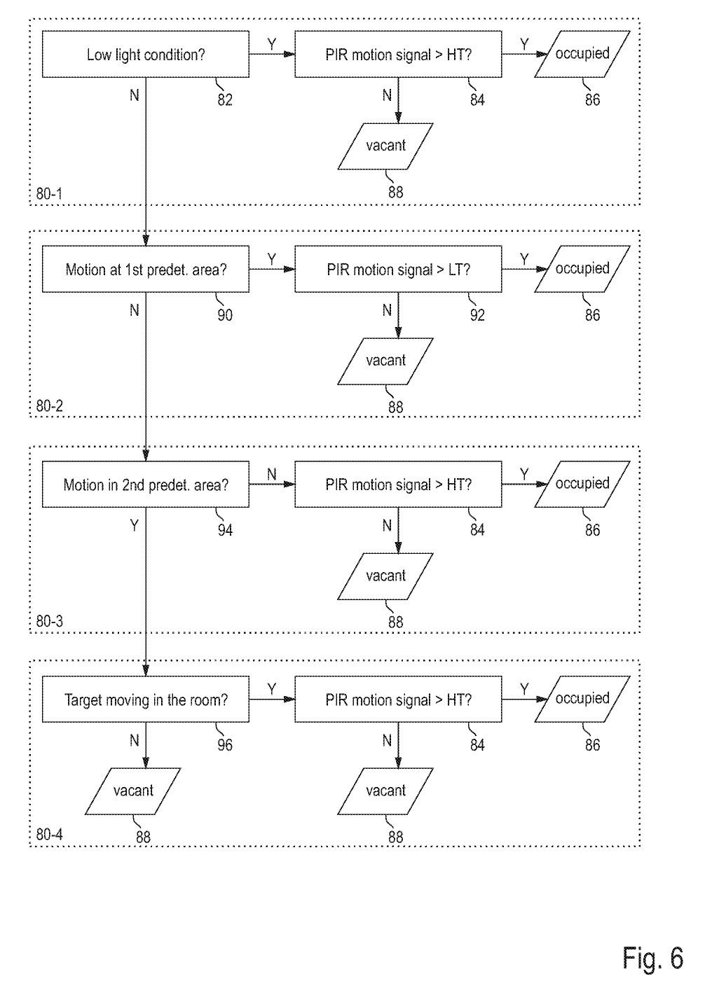

FIG. 6 shows different options for rules based on which the control unit 24 may generate and provide the first signal 34 or the second signal 36 (i.e. the control unit 24 may be configured to implement the tasks shown in FIG. 6). The rules are logically grouped as blocks 80, i.e., blocks 80-1, 80-2, 80-3, and 80-4. The blocks 80 can be rearranged, other blocks 80 can be added, one or more blocks 80 can be omitted and each individual block 80 may also be used in isolation.

Block 80-1 makes a determination 82, whether a low light condition is present. If this is the case, branch Y is followed to reach the determination 84, whether the motion signal 28 from the PIR sensor 16 is above the high threshold HT. If this is the case, “occupied” 86 is provided as the first signal 34. If this is not the case, “vacant” 88 is provided as the second signal 36 or the first signal 34 is not provided as an alternative to indicate “vacant”.

In block 80-2 a determination 90 is made, whether motion is indicated in the first predetermined area 44. If this is the case, a determination 92 is reached via branch Y, where it is determined whether the motion signal 28 from the PIR sensor 16 is above the low threshold LT. If this is the case, “occupied” 86 will be provided as the first signal 34. If this is not the case, “vacant” 88 will be provided as the second signal 36 or the first signal 34 is not provided as an alternative to indicate “vacant”.

In block 80-3 a determination 94 is made, whether the motion is present in the second predetermined area 46. If this is not the case, the determination 84 is reached via the branch N, where it is determined whether the motion signal 28 from the PIR sensor 16 is above the high threshold HT. If this is the case, “occupied” 86 will be provided as the first signal 34. If this is not the case, “vacant” 88 will be provided as the second signal 36 or the first signal 34 is not provided as an alternative to indicate “vacant”.

In block 80-4 a determination 96 is made, whether the information from the imaging sensor 20 indicates a target moving in the room. If this is the case, a determination 84 is reached via branch Y, where it is determined whether the motion signal 28 from the PIR sensor 16 is above the high threshold HT. If this is the case, “occupied” 86 will be provided as the first signal 34. If this is not the case, “vacant” 88 will be provided as the second signal 36 or the first signal 34 is not provided as an alternative to indicate “vacant”.

For exemplary embodiments, the blocks 80 may be provided as a part of task 66, see FIG. 4. Then, once “occupied” 86 or “vacant” 88 are provided to the output 26 of the control unit 24, the method 60 will continue with task 62.

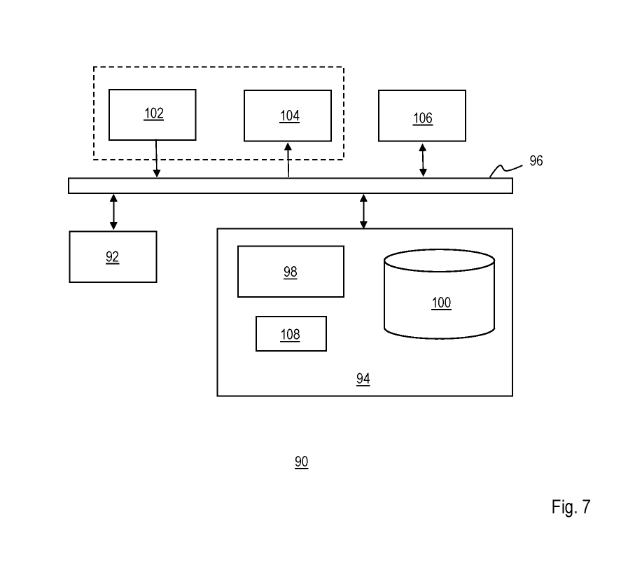

FIG. 7 depicts a block diagram illustrating an exemplary data processing system 90, according to one embodiment of the present disclosure. Such a data processing system could be configured to e.g. function as the control unit 24 described herein or/and as any other system or processing device configured to implement various mechanisms related to detecting presence of a target in a room as described herein. For example, the data processing system 90 may be used to implement a processing device of the PIR sensor 16 and/or a processing device of the imaging sensor 20, in the embodiments where such processing devices are implemented, as well as the lighting control unit 54 as described above.

As shown in FIG. 7, the data processing system 90 may include at least one processor 92 coupled to memory elements 94 through a system bus 96. As such, the data processing system may store program code within memory elements 94. Further, the processor 92 may execute the program code accessed from the memory elements 94 via a system bus 96. In one aspect, the data processing system may be implemented as a computer that is suitable for storing and/or executing program code. It should be appreciated, however, that the data processing system 90 may be implemented in the form of any system including a processor and a memory that is capable of performing the functions described within this specification.

The memory elements 94 may include one or more physical memory devices such as, for example, local memory 98 and one or more bulk storage devices 100. The local memory may refer to random access memory or other non-persistent memory device(s) generally used during actual execution of the program code. A bulk storage device may be implemented as a hard drive or other persistent data storage device. The processing system 90 may also include one or more cache memories (not shown) that provide temporary storage of at least some program code in order to reduce the number of times program code must be retrieved from the bulk storage device 100 during execution.

Input/output (I/O) devices depicted as an input device 102 and an output device 104, optionally, can be coupled to the data processing system. Examples of input devices may include, but are not limited to, a keyboard, a pointing device such as a mouse, or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 7 with a dashed line surrounding the input device 102 and the output device 104). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 106 may also, optionally, be coupled to the data processing system 90 to enable it to become coupled to other systems, computer systems, remote network devices, and/or remote storage devices through intervening private or public networks. The network adapter may comprise a data receiver for receiving data that is transmitted by said systems, devices and/or networks to the data processing system 90, and a data transmitter for transmitting data from the data processing system 90 to said systems, devices and/or networks. Modems, cable modems, and Ethernet cards are examples of different types of network adapter that may be used with the data processing system 90.

As pictured in FIG. 7, the memory elements 94 may store an application 108. In various embodiments, the application 108 may be stored in the local memory 98, the one or more bulk storage devices 100, or apart from the local memory and the bulk storage devices. It should be appreciated that the data processing system 90 may further execute an operating system (not shown in FIG. 7) that can facilitate execution of the application 108. The application 108, being implemented in the form of executable program code, can be executed by the data processing system 90, e.g., by the processor 92. Responsive to executing the application, the data processing system 90 may be configured to perform one or more operations or method steps described herein.

### Selected Examples

Example 1 is an apparatus for detecting a presence of a target in a room, the apparatus comprising a motion-sensitive PIR sensor with a first field of view, an imaging sensor with a second field of view, and a control unit connected to the PIR sensor and to the imaging sensor and having an output, wherein the PIR sensor is adapted to provide a motion signal indicative of a motion detected in the first field of view and the imaging sensor is adapted to capture a scene in the second field of view and to generate at least a first image at a first time and a second image at a second time after the first time, wherein the control unit is adapted to provide one of a first signal and a second signal different from the first signal depending on the strength of the motion detected and a comparison of the first image and the second image for differences indicating a motion, and wherein the first signal is adapted to indicate the presence of the target and the second signal is adapted to indicate an absence of the target.

In Example 2, Example 1 can further include the control unit being further adapted to provide the first signal if the comparison of the first and second images indicates a motion and if the motion signal from the PIR sensor is above a noise level of the motion signal.

In Example 3, any one of the above Examples can further include the control unit being further adapted to provide the first signal if the comparison of the first and second images indicates a motion in a first predetermined area of the second field of view and if the motion signal from the PIR sensor is above a noise level of the motion signal.

In Example 4, any one of the above Examples can further include the control unit being further adapted to provide the second signal if the control unit determines a low light condition based on at least one of the first image and the second image, and if the motion signal from the PIR sensor is below a high threshold of the motion signal.

In Example 5, any one of the above Examples can further include the control unit being further adapted to provide the second signal if the comparison of the first and second images indicates a motion only in a second predetermined area of the second field of view.

In Example 6, any one of the above Examples can further include the control unit being further adapted to provide the second signal if the comparison of the first and second images indicates a motion only in a second predetermined area of the second field of view and if the motion signal from the PIR sensor is above a low threshold.

In Example 7, any one of the above Examples can further include the control unit being further adapted to provide the first signal if the motion signal from the PIR sensor is above a high threshold.

In Example 8, any one of the above Examples can further include the imaging sensor being adapted to provide the first and second images as two-dimensional spatial data comprising information on luminance distribution or contrast distribution.

In Example 9, any one of the above Examples can further include control unit being further adapted such that the comparison of the first and second images indicates a motion only if a moving shape determined by the comparison meets at least one predefined criterion.

In Example 10, any one of the above Examples can further include the control unit being further adapted to compare the strength of the motion detected to a low threshold, wherein the low threshold is set to correspond to a target entering the first field of view.

In Example 11, any one of the above Examples can further include the control unit being further adapted to compare the strength of the motion detected to a high threshold, wherein the high threshold is set to correspond to a target moving within the first field of view.

In Example 12, any one of the above Examples can further include the control unit being further adapted to provide the second signal if the control unit determines no low light condition based on at least one of the first image and the second image, and if the comparison of the first and second images does not indicate a motion.

In Example 13, any one of the above Examples can further include the PIR sensor and the imaging sensor being arranged in proximity to each other.

In Example 14, any one of the above Examples can further include the PIR sensor and the imaging sensor being arranged in a common housing.

Example 15 is a system for controlling lighting in a room, the system comprising an apparatus according to any one of the above Examples and a light source connected to the output of the control unit, wherein the light source is adapted to be controlled based on the first signal and the second signal.

Example 16 is a method for detecting a presence of a target in a room, the method comprising: providing a motion signal indicative of a motion detected in a first field of view of a motion-sensitive PIR sensor, generating at least a first image at a first time and a second image at a second time after the first time of a scene in a second field of view of an imaging sensor, and providing one of a first signal and a second signal different from the first signal depending on the strength of the motion detected and a comparison of the first image and the second image for differences indicating the motion, where the first signal is adapted to indicate the presence of the target and the second signal is adapted to indicate an absence of the target.

Example 17 is a use of an apparatus according to any one of the examples 1-15 for controlling lighting in a room depending on the presence of the target.

### Variations and Implementations

While embodiments of the present disclosure were described above with references to exemplary implementations as shown in FIGS. 1-7, a person skilled in the art will realize that the various teachings described above are applicable to a large variety of other implementations.

While some functionality is described above as carried out by the control unit 24, such functionality can be distributed among various processing devices. For example, comparison of first and second images to detect motion in the field of view of the imaging sensor can be carried out by the imaging sensor itself (e.g. by a processing device of the imaging sensor) and, instead of providing the first and second images to the control unit, the imaging sensor may provide to the control unit information indicative of the result of the processing of these images—e.g. an outcome as to whether motion is detected based on the comparison of acquired images. In another example, comparison of the motion signal generated by the PIR sensor to one or more thresholds may be carried out by the PIR sensor itself (e.g. by a processing device of the PIR sensor) and, instead of providing the motion signal to the control unit, the PIR sensor may provide to the control unit information indicative of the result of the processing of the motion signal—e.g. an outcome as to whether motion is detected based on the comparison of the motion signal with one or more thresholds to assess the strength of the motion/motion signal.

In some example scenarios, the features discussed herein can be applicable to surveillance applications, safety-critical industrial applications, automotive systems, medical systems, patient monitoring, medical instrumentation, home healthcare, and scientific instrumentation. In yet other example scenarios, the teachings of the present disclosure can be applicable in the industrial markets that include process control systems that help drive productivity, energy efficiency, and reliability.

In the discussions of the embodiments above, components of various systems described herein can readily be replaced, substituted, or otherwise modified in order to accommodate particular circuitry needs. Moreover, it should be noted that the use of complementary electronic devices, hardware, software, etc. offer an equally viable option for implementing the teachings of the present disclosure related to detecting presence of a target in a room.

Parts of various systems for implementing improved mechanisms for detecting presence of a target in a room as proposed herein can include electronic circuitry to perform the functions described herein. In some cases, one or more parts of the system can be provided by a processor or, more generally, a data processing system, specially configured for carrying out the functions described herein. For instance, the data processing system may include one or more application specific components, or may include programmable logic gates which are configured to carry out the functions describe herein. The circuitry can operate in analog domain, digital domain, or in a mixed signal domain. In some instances, the data processing system may be configured to carrying out the functions described herein by executing one or more instructions stored on a non-transitory computer readable storage medium.

In one example embodiment, any number of electrical circuits of FIGS. 1-7 may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), computer-readable non-transitory memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow a processor to carry out those functionalities.

In another example embodiment, electrical circuits which may be used to implement teachings of FIGS. 1-7 may be implemented as stand-alone modules (e.g., a device with associated components and circuitry configured to perform a specific application or function) or implemented as plug-in modules into application specific hardware of electronic devices. Note that particular embodiments of the present disclosure implementing improved mechanisms for detecting presence of a target in a room may be readily included in a system on chip (SOC) package, either in part, or in whole. An SOC represents an IC that integrates components of a computer or other electronic system into a single chip. It may contain digital, analog, mixed-signal, and often radio frequency functions: all of which may be provided on a single chip substrate. Other embodiments may include a multi-chip-module (MCM), with a plurality of separate ICs located within a single electronic package and configured to interact closely with each other through the electronic package. In various other embodiments, the functionalities of improved mechanisms for detecting presence of a target in a room proposed herein may be implemented in one or more silicon cores in Application Specific Integrated Circuits (ASICs), Field Programmable Gate Arrays (FPGAs), and other semiconductor chips.

It is also imperative to note that all of the specifications, dimensions, and relationships outlined herein (e.g., the number of processors, logic operations, etc.) have only been offered for purposes of example and teaching only. Such information may be varied considerably without departing from the spirit of the present disclosure, or the scope of the appended claims. The specifications apply only to one non-limiting example and, accordingly, they should be construed as such. In the foregoing description, example embodiments have been described with reference to particular processor and/or component arrangements. Various modifications and changes may be made to such embodiments without departing from the scope of the appended claims. The description and drawings are, accordingly, to be regarded in an illustrative rather than in a restrictive sense.

Note that with the numerous examples provided herein, interaction may be described in terms of two, three, four, or more electrical components. However, this has been done for purposes of clarity and example only. It should be appreciated that the system can be consolidated in any suitable manner. Along similar design alternatives, any of the illustrated components, modules, and elements of FIGS. 1-7 may be combined in various possible configurations, all of which are clearly within the broad scope of this Specification. In certain cases, it may be easier to describe one or more of the functionalities of a given set of flows by only referencing a limited number of electrical elements. It should be appreciated that the electrical circuits of FIGS. 1-7 and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

It is also important to note that the functions related to the improved mechanisms for detecting presence of a target in a room as proposed herein illustrate only some of the possible functions that may be executed by, or within, system illustrated in FIGS. 1-7. Some of these operations may be deleted or removed where appropriate, or these operations may be modified or changed considerably without departing from the scope of the present disclosure. In addition, the timing of these operations may be altered considerably. The preceding operational flows have been offered for purposes of example and discussion. Substantial flexibility is provided by embodiments described herein in that any suitable arrangements, chronologies, configurations, and timing mechanisms may be provided without departing from the teachings of the present disclosure.

Numerous other changes, substitutions, variations, alterations, and modifications may be ascertained to one skilled in the art and it is intended that the present disclosure encompass all such changes, substitutions, variations, alterations, and modifications as falling within the scope of the appended claims.

Although the claims are presented in single dependency format in the style used before the USPTO, it should be understood that any claim can depend on and be combined with any preceding claim of the same type unless that is clearly technically infeasible.

Note that all optional features of the apparatus described above may also be implemented with respect to the method or process described herein and specifics in the examples may be used anywhere in one or more embodiments.

What is claimed is:

1. An apparatus for detecting presence of a target in a scene, the apparatus comprising:
a passive infrared (PIR) sensor having a first field of view and configured to generate a motion signal indicative of a motion detected in the first field of view;
an imaging sensor having a second field of view and configured to capture at least a first and a second images of the scene in the second field of view at different points in time; and
a control unit configured to generate a first signal indicating a presence of the target in the scene or a second signal indicating an absence of the target in the scene based on the motion signal and a comparison of the first and second images for differences indicating a motion detected in the second field of view.

2. The apparatus according to claim 1, wherein the control unit is further configured to apply the first signal or the second signal to a further system comprising one or more devices sources to control a state of the one or more devices.

3. The apparatus according to claim 2, wherein controlling the state of the one or more devices comprises:
ensuring that the one or more devices are set to operate in a first state if the control unit generates the first signal, and/or
ensuring that the one or more devices are set to operate in a second state if the control unit generates the second signal.

4. The apparatus according to claim 3, wherein the second state is a state where the one or more devices consume less power than in the first state.

5. The apparatus according to claim 2, wherein the control unit is configured to apply the first signal or the second signal to the further system after a delay time period following the generation of the first signal or the second signal.

6. The apparatus according to claim 2, wherein the control unit is configured to apply the first signal or the second signal to the further system after the first signal or the second signal is generated several times in a row.

7. The apparatus according to claim 1, wherein the control unit is configured to generate the first signal if the comparison indicates the motion detected in the second field of view and the motion signal is above a threshold.

8. The apparatus according to claim 1, wherein the control unit is configured to generate the second signal if the comparison indicates a low light condition and the motion signal is below a threshold.

9. The apparatus according to claim 1, wherein the control unit is configured to generate the second signal if the comparison indicates absence of a low light condition and indicates no motion detected in the second field of view.

10. The apparatus according to claim 1, wherein the control unit is configured to generate the second signal if the comparison indicates the motion detected in the second field of view and the motion signal is below a threshold.

11. The apparatus according to claim 1, wherein the control unit is configured to generate the second signal if the comparison indicates the motion detected only in a predetermined area of the second field of view and the motion signal is above a threshold.

12. The apparatus according to claim 1, wherein the control unit is configured to generate the second signal if the comparison indicates no motion detected in a predetermined area of the second field of view and the motion signal is above a threshold.

13. The apparatus according to claim 1, wherein the control unit is configured to generate the first signal if the comparison indicates a motion detected in a predetermined area of the second field of view and the motion signal is above a first threshold but below a second threshold, the second threshold being higher than the first threshold.

14. The apparatus according to claim 1, wherein the control unit is configured to provide the first signal or the second signal at an output of the control unit, and where the control unit is configured to keep the first signal or the second signal at the output unchanged of the comparison of the first and second images indicates a motion detected only outside of a predetermined area of the second field of view.

15. The apparatus according to claim 1, wherein the first and second images include two-dimensional spatial data comprising information on luminance distribution or contrast distribution.

16. The apparatus according to claim 1, wherein the comparison of the first and second images for the differences comprises indicating the motion detected in the second field of view if a moving shape determined by the comparison meets at least one predefined criterion.

17. The apparatus according to claim 16, wherein the moving shape meeting the at least one predefined criterion comprises the moving shape having a size greater than a predetermined minimum size or/and the moving shape moving with a speed greater than a predetermined minimum speed.

18. The apparatus according to claim 1, wherein the first field of view at least partially overlaps with the second field of view.

19. A method comprising:
receiving, from a passive infrared (PIR) sensor having a first field of view, a motion signal generated by the PIR sensor, the motion signal indicative of a motion in the first field of view;
receiving, from an imaging sensor having a second field of view, at least a first and a second images of the scene captured by the imaging sensor at different points in time; and
providing a first signal indicating a presence of a target in a scene or a second signal indicating an absence of the target in the scene based on the motion signal and a comparison of the first and second images for differences indicating a motion detected in the second field of view.

20. The method according to claim 1, further comprising controlling one or more further devices to operate in one of a plurality of operating states based on whether the first signal or the second signal is provided.
